(19) United States
(12) Patent Application Publication
(10) Pub. No.: US 2011/0300406 A1
(43) Pub. Date: Dec. 8, 2011

(54) PAINTED METAL PARTS WITH NON-HEXAVALENT CHROMIUM CHEMICAL CONVERSION COATING AND PROCESS

(75) Inventor: ROBERT J. DEES, Vista, CA (US)

(73) Assignee: ALLFAST FASTENING SYSTEMS, INC., City of Industry, CA (US)

(21) Appl. No.: 13/153,098

(22) Filed: Jun. 3, 2011

Related U.S. Application Data
(60) Provisional application No. 61/351,670, filed on Jun. 4, 2010.

(51) Int. Cl. B32B 15/01; B05D 3/10; B05D 1/36

(52) U.S. Cl. 428/651; 427/405; 427/383.7

(57) ABSTRACT

A method including forming a first layer comprising a non-hexavalent chromium chemical conversion coating on a metal surface; and forming a second layer on the first layer through a sol gel process. An apparatus including a metal component having at least one surface; a first layer comprising a chemical conversion coating on the at least one surface; and a second layer derived from a sol gel composition on the first layer.

### CROSS-REFERENCE TO RELATED APPLICATION

The application claims the benefit of the earlier filing date of co-pending U.S. Provisional Patent Application No. 61/351,670, filed Jun. 4, 2010 and incorporated herein by reference.

### FIELD OF THE INVENTION

Metal surface treatment.

### BACKGROUND

The susceptibility of various metals to corrosion has been extensively studied. One field where this is particularly important is the aircraft or airline industry. The exterior of most aircraft are made primarily of metal material, particularly aluminum and titanium. In order to improve the corrosion resistance of metal component parts, particularly, an exterior surface of metal component parts, conversion coatings have been developed. Conversion coatings are generally electrolytic or chemical films that promote adhesion between the metal and adhesive resins. A common electrolytic process is anodization in which a metal material is placed in an immersing solution to form a porous, micro rough surface into which an adhesive can penetrate. Chemical films for treating titanium or aluminum include phosphate-fluoride coating films for titanium and chromate conversion films for aluminum.

Painting of metal surfaces is also of important commercial interest. In the aircraft or airline industry, the exterior metal surface of many commercial and government aircraft are painted at considerable expense. Techniques have been developed, through the use, for example, conversion coatings or sol gel processes to improve the adhesion of paints, particularly, urethane coatings that are common in the aircraft applications. With respect to sol gel coatings, U.S. Pat. Nos. 5,789,085; 5,814,137; 5,849,110; 5,866,652; 5,869,140; 5,869,141; and 5,939,197 describe sol gel technologies, particularly zirconium-based sol gel technologies for treating metal surfaces and adhesion, particularly, paint adhesion.

With respect to metal panels that make up an aircraft, sol gel coatings such as those described in the above-referenced patents have been shown to improve adhesion of epoxy-based and polyurethane paints.

Most panels (e.g., metal panels) that make up, for example, the body of an aircraft are held together by fasteners, particularly rivets. Such fasteners, particularly, the exposed surface of such fasteners must meet corrosion resistance standards mandated by aircraft manufacturers. The fasteners must also be able to maintain a coating, such as a paint (e.g., epoxy-based, polyurethane, polyimide) that may be utilized on the panels that make up the aircraft. One problem that has been identified is that paint that otherwise adheres acceptably to the exterior surfaces of aircraft panels, does not acceptably adhere to the fasteners (e.g., rivets) that join the panels. The condition where paint adherence failure occurs with fasteners in the aircraft industry is known as rivet rash.

In addition to paint adherence, metal panels in the aircraft or airline industry must meet certain corrosion resistance standards. One corrosion resistance standard for conversion coatings of aluminum is a salt spray test in accordance with MIL-DTL-5541. According to this standard, the chemical conversion coated panels undergo salt spray exposure for a minimum of 168 hours and must show no indication of corrosion under examination of approximately 10× magnification. Although not specifically stated in the MIL-DTL-5541 standard, aircraft manufacturers often require that fasteners such as rivets meet certain corrosion resistance standards. One aircraft manufacturer standard for rivets is a salt spray exposure for a minimum of 48 hours without indication of corrosion.

### BRIEF DESCRIPTION OF THE DRAWINGS

Features, aspects, and advantages of embodiments of the invention will become more thoroughly apparent from the following detailed description, appended claims, and accompanying drawings in which:

FIG. 1 shows a schematic side view of a rivet having the exposed surfaces thereof coated with a chemical conversion coating and a sol gel coating.

FIG. 2 shows the rivet of FIG. 1 having a paint coating applied to one surface of the rivet.

FIG. 3 shows a flow chart of a method for coating a metal surface.

### DETAILED DESCRIPTION

A method of coating a metal surface is described. In one embodiment, a method includes forming a first layer including a chemical conversion coating on a metal surface and forming a second layer on the first layer through a sol gel process (e.g., a sol gel film). The method is useful, for example, in treating metal surfaces, particularly surfaces of metal (e.g., aluminum, titanium) fasteners to improve the corrosion resistance and the adhesion properties of the fastener for further treatment, such as for painting.

An apparatus is also described. In one embodiment, an apparatus includes a metal component, such as an aluminum fastener (e.g., rivet) having at least one surface. The at least one surface of the metal component includes a first layer comprising a chemical conversion coating and a second layer derived from a sol gel composition on the first layer. Through the use of a first and second layer, the adhesion properties of the metal component may be improved, particularly, for paint adherence to the at least one surface.

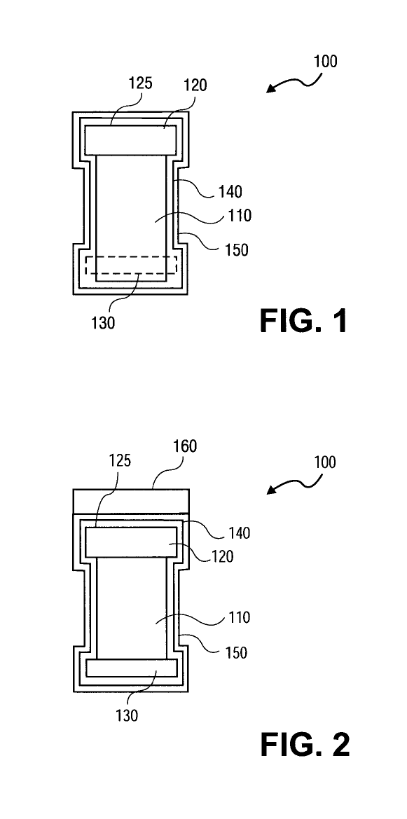

FIG. 1 shows a schematic side view of a fastener. Fastener 100 is, for example, a rivet suitable for use in fastening metal component panels of aircraft or other vehicles. In this embodiment, fastener 100 is a metal material, such as aluminum alloy. Fastener 100 includes shank 110, head 120, and upset head 130 (shown in dashed lines in FIG. 1 as an upset head is formed on installation). In the embodiment where fastener 100 is a rivet, in one embodiment, shank 110, head 120, and upset head 130 are a unitary body of aluminum material or alloy. Suitable grades of aluminum for a rivet in the aircraft or airline industry include, but are not limited to, 2017 and 7050 aluminum. Representative diameters, in inches, for rivets for use in the aircraft industry to fasten panels range from 3/32 to 8/32 and larger, depending on the particular fastening or other application.

Referring to FIG. 1, fastener 100 includes first layer 140 of a chemical conversion coating, in this embodiment, directly disposed on or in direct contact with exterior and/or exposed surfaces of fastener 100. For an aluminum material of fastener 100 (e.g., shank 110, head 120, and upset head 130 of aluminum material), a suitable chemical conversion coating includes a non-hexavalent chromate conversion coating. In recent years, countries have become concerned about the use of hazardous materials, including hexavalent chromium, in certain manufacturing industries. In July 2006, for example, the European Union directed to Restriction of Hazardous Substances Directive or RoHS be enforced and become law in each member state. The RoHS directive restricts the use of six hazardous materials, including hexavalent chromium, in the manufacture of various types of electronic equipment. Heretofore, many chemical conversion coatings in the aircraft or airline industry have used hexavalent chromium, because certain of such coatings have proven to be acceptable in passing corrosion resistance standards such as MIL-DTL-5541.

One suitable coating is a trivalent chromium conversion coating such as LUSTER-ON® Aluminescent, commercially available from Luster-On Products, Inc. of Springfield, Mass. LUSTER-ON® Aluminescent is licensed from the United States Navy under U.S. Pat. Nos. 6,375,726; 6,571,532; 6,521,029; and 6,527,841. LUSTER-ON® Aluminescent includes a trivalent chromium complex and potassium hexafluorozirconate. A suitable thickness of first layer 140 of LUSTER-ON® Aluminescent on a fastener that is an aluminum rivet is, for example, on the order of less than one mil to pass the MIL-DTL-5541 salt spray standard for a fastener (e.g., 168 hour salt spray exposure).

In addition to first layer 140, fastener 100 shown in FIG. 1 also includes second layer 150 shown disposed on first layer 140. In one embodiment, second layer 150 is formed by a sol gel process (e.g., a sol gel film). Representative sol gel films that may be suitable as second layer 150 are sol gel films that, in one embodiment, promote adhesion of an epoxy or a polyurethane coating (e.g., paint) to fastener 100. In one embodiment, second layer 150 of a sol gel film is formed according to the teachings described in U.S. Pat. Nos. 5,789,085; 5,814,137; 5,849,110; 5,866,652; 5,869,140; 5,869,141; and 5,939,197. Suitable sols include solutions of zirconium organometallic salts, including alkoxyzirconium organometallic salts, such as tetra-i-propoxyzirconium or tetra-n-propoxyzirconium and an organosilane coupling agent, such as 3-glycidoxypropyl trimethoxysilane for epoxy or polyurethane systems. One suitable sol gel film for epoxy or polyurethane systems (e.g., an epoxy-based or polyurethane-based coating) is produced by components provided Advanced Chemistry and Technology (AC Tech™) of Garden Grove, Calif. Such components include glacial acetic acid (AC Tech™-131 Part A); a sol of zirconium n-propoxide (greater than 65 percent by weight) and n-propanol (greater than 25 percent by weight) (AC Tech™-131 Part B); an organosilane coupling agent of 3-glycidoxypropyl trimethoxysilane (AC Tech™-131 Part C); and water (AC Tech™-131 Part D). The component parts are combined/mixed to form a sol gel solution. A sol gel film for second layer 150 may be applied by immersing, spraying, or drenching fastener 100 with a sol gel solution without rinsing. After application, fastener 100 including the sol gel solution is dried at an ambient temperature or heated to a temperature between ambient of 140° F. to form a sol gel film. A suitable thickness of second layer 150 on a fastener that is an aluminum rivet having a chemical conversion coating layer (e.g., first layer 140) is on the order of less than one mil. The embodiment of fastener (e.g., rivet) shown in FIG. 1 with first layer 140 of LUSTER-ON® Aluminescent chemical conversion material and second layer 150 of the referenced AC Tech™ components, a layer formed by a sol gel process (e.g., a sol gel film), passes a 168 hour salt spray test performed in accordance with MIL-DTL-5541. A rivet with only the sol gel film formed by the AC Tech™ components did not pass a similar 168 hour salt spray test.

FIG. 2 shows fastener 100 of FIG. 1 following the introduction of coating 160, such as a paint. Fastener 100 is a rivet in this example and is an installed configuration with upset head 130 formed. Coating 160, as a paint, includes an epoxy-based paint system, a polyurethane-based system, or a polyimide-based system. As noted above, fastener 100 including first layer 140 of a chemical conversion coating, and second layer 150 of a sol gel film produced from the AC Tech™ components has been shown to meet the corrosion resistance standard of MIL-DTL-5541 (e.g., a 168 hour salt spray test). Fastener 100 of an aluminum material with first layer 140 of LUSTER-ON® Aluminescent and second layer 150 of a sol gel film produced from AC Tech™ components referenced above has also been shown to have acceptable adhesion properties for coating 160 of an epoxy-based or polyurethane-based coating (paint) than a fastener (e.g., rivet) coated with only a chemical conversion layer.

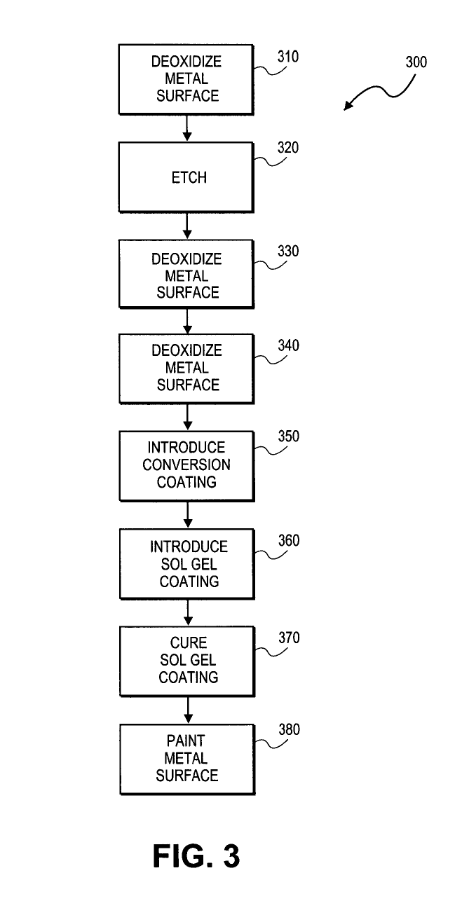

FIG. 3 shows a flow chart of a process of forming multiple layers on a metal surface such as a metal fastener, for example, metal fastener 100 described with reference to FIG. 1 and FIG. 2 and the accompanying text. The following process is described with respect to rivets as fasteners. Such rivets are suitable for use in the aircraft industry to fasten panels of the aircraft body to one another. In such instances, the head of the individual rivets will be exposed to the environment and therefore must meet the standards of the aircraft manufacturers (e.g., standard such as MIL-DTL-5541 for corrosion resistance and paint adhesion standard).

Referring to FIG. 3 and process 300, it is appreciated that metals such as aluminum tend to oxidize in the presence of oxygen, such as atmospheric oxygen. In block 310, the metal surface, particularly metal surfaces that are to be exposed such as heads of fasteners or rivets (e.g., a 2017 aluminum rivet), are deoxidized by chemical or physical (e.g., sputtering) means to remove an oxide coating or layer from the surface of the metal.

In one embodiment, for example, the deoxidation may include deoxidizing the fastener in a solution of between approximately 12 percent to 15 percent nitric acid (HNO₃) for a period of approximately 30 seconds, followed by a rinse (e.g., a water rinse). Other deoxidizing agents, concentrations, and process times besides those recited here may be used.

At block 320, the fastener is etched with an etching solution. In one embodiment, the etching solution may contain, for example, an alkaline etchant such as DURAETCH™ commercially available from DURACHEM of Lake Elsinore, Calif. In one embodiment, a fastener such as a rivet is exposed to a concentration level of DURAETCH™ at approximately 8.5 ounces per gallon for approximately 15 seconds at approximately 150° F., followed by an aqueous (e.g., double water) rinse. Other etchants, concentrations, and process times and temperatures may be used beyond the specific example stated above.

In one embodiment, the fastener is exposed to a second deoxidization treatment, at block 14, in a manner similar to that set forth above for the deoxidation at block 310. The deoxidation at block 330 may advantageously prepare the surface of the fastener to receive a corrosion inhibiting or resisting coating and increase adhesion of the sol gel coating, to be applied at a later time. The fastener may then be rinsed in, for example, a double water rinse (e.g., rinsing the fastener twice in successive containers of water).

At block 340, in one embodiment, the fastener is exposed to a third deoxidization treatment similar to that set forth above for the deoxidation at block 310. Without wishing to be bound by a particular result or objective of the multiple deoxidation treatments or the requirement for multiple deoxidation treatments, the first and second deoxidation treatments tend to remove smut from the fastener while the third deoxidation treatment prepares the clean surface for subsequent processing.

Following the deoxidization of a metal surface or surfaces, a conversion coating is introduced (block 350) to the metal surface or metal surface of the rivet(s). For an aluminum alloy rivet (e.g., 2017, 7050 alloy rivet), a chemical conversion coating, such as LUSTER-ON® Aluminescent, is applied in accordance with MIL-DTL-5541. Suitable techniques for introducing chemical conversion coating of LUSTER-ON® Aluminescent include immersion, spraying, or drenching the metal surface in a solution of the chemical conversion coating material. In the example of rivets as fasteners, a number of rivets may be placed in a basket, such as a perforated metal basket, and immersed in a chemical conversion coating solution for a few to several minutes (e.g., two to seven minutes).

Following the introduction of a conversion coating, the rivet(s) are rinsed in one or more successive water baths and dried, such as by exposing the rivet to a centrifugal or other drying process, including a standing air dry process. The rivet(s) is/are then brought to room temperature if necessary. Within a specified period, such as within 24 hours, a sol gel film is introduced on an exterior surface of the rivet (block 360). Suitable ways for introducing a sol gel film include immersion coating, spraying, and drenching the rivet(s) in a sol gel solution. In the example where a sol gel coating is applied by immersing, representatively the rivet(s) is/are immersed in a solution including a sol gel for a period of a few to several minutes. In one embodiment, the rivet(s) is/are immersed in a solution including a sol gel for two to three minutes. During immersion, the sol gel solution may be agitated to improve the coating uniformly. The rivet(s) is/are then removed from a sol gel coating solution and centrifuged to remove excess sol gel solution (e.g., centrifuged in a DESCO™ or similar centrifuge for 30 seconds).

Once a sol gel coating is applied to a rivet(s), the sol gel coating is cured (block 370). In one embodiment, a curing process includes heating the rivet in a preheated oven to a cured temperature. A cure temperature for the sol gel coating solution described above commercially available from Advanced Chemistry and Technology includes exposing the rivet(s) including the sol gel coating to a preheated oven at a 130° F.±10° F. for a sufficient time, typically on the order of 45 to 90 minutes. The following table illustrates curing times for curing a number of rivets at one time (e.g., a number of rivets as a layer in a perforated tray).

| RIVET | TRAY THICKNESS | DRYING TIME |
|---|---|---|
| DIAMETER (x 1/32) | (inches) | (MINUTES) |
| −3 and −4 | 0.5 | 50-60 |
| −5 thru −7 | 1 | 50-60 |
| −8 and larger | 1.5 | 50-60 |

Following curing of a layer formed by sol gel process (e.g., a sol gel film), the rivet(s) is/are cooled and a surface of the rivet(s) is/are ready for a coating. Representatively, an epoxy, polyurethane, or polyimide coating may be applied to the surface containing the sol gel film (block 380).

### Example

Five 10-inch by 14¾-inch panels of 2024-T3 clad aluminum were prepared each containing four rows of 10 rivets (40 rivets total). Three panels contained 7050 alloy BACR15FV solid rivets and two panels contained 2017 alloy BACR15GF rivets (counter sunk rivet with dome). Each of the five panels had rivets having a sol gel formed film (second layer) over a trivalent chromium conversion coating (first layer). A sixth panel of 2017 alloy BACR15GF rivets had ten rivets with the trivalent chromium conversion coating and no sol gel formed film. All rivets were painted according to Boeing aircraft paint standards. Following painting, the rivets of each panel were subjected to a dry tape scribe test to evaluate paint adhesion.

The rivets were prepared as follows:

7050 Alloy (BACR15FV rivet): Rivets were deoxidized by approximately 15 percent nitric acid solution for approximately 30 seconds; etched for approximately 15 seconds in a solution of DURAETCH™ solution for 20 minutes; deoxidized again in a bath of 15 percent nitric acid solution; immersed in LUSTER-ON® Aluminescent (3 oz/gal, pH 3.5-4) for five minutes at room temperature; rinsed in water; centrifugally dried; immersed in a sol gel solution from AcTeh, AcTech™-131 Parts A-D, for five minutes; and cured at 130° F. for approximately 45 minutes.

2017 Alloy (BACR15GF rivet): Rivets were deoxidized by 15 percent nitric acid solution for approximately 30 seconds; etched for approximately 15 seconds in a solution of DURAETCH™ at 50° F.; deoxided twice more in sequential baths of 15 percent nitric acid solution (approximately 30 seconds each); immersed in LUSTER-ON® Aluminescent (3 oz/gal, pH 3.5-4) for five minutes at room temperature; rinsed in water; centrifugally dried; immersed in a sol gel solution from AcTeh, AcTech™-131 Parts A-D, for five minutes; and cured at 130° F. for approximately 45 minutes.

As noted above, one panel of 2017 alloy BACR15GF rivets did not include a film formed by immersing in a sol gel solution.

Following preparation, the rivets were installed on the six panels and painted with a BMS10-72 Type VIII primer and a BMS10-72 Type III topcoat, color BAC 5289 per D6-1816AU. Each panel was cured at 120° F. for four hours followed by a one week cure at ambient.

Following curing, the rivets were subject to a dry paint adhesion test, per BSS7225 Type I, class 5 (45 degree cross hatch scribes).

| Lab No. | Panel # | Condition | Results |
|---|---|---|---|
| 3445L | 1 | FV/Sol Gel | 1 of 40 rivets with greater |
| | | | than 35% paint removal |
| 3446L | 2 | FV/Sol Gel | No rivets with greater |
| | | | than 35% paint removal |
| 3447L | 3 | FV/Sol Gel | 1 of 40 rivets with greater |
| | | | than 35% paint removal |
| 3448L | 4 | GF/Sol Gel | No rivets with greater |
| | | | than 35% paint removal |
| 3449L | 5 | GF/Sol Gel | 1 of 40 rivets with greater |
| | | | than 35% paint removal |
| 3450L | 6 | GF/No Sol Gel | 7 of 10 rivets with greater |
| | | | than 35% paint removal |

The results show superior paint adhesion performance when a coating formed by a sol gel process is formed over a non-hexavalent conversion coating.

In the preceding paragraphs, specific embodiments are described. It will, however, be evident that various modifications and changes may be made thereto without departing from the broader spirit and scope of the claims. The specification and drawings are, accordingly, to be regarded in an illustrative rather than a restrictive sense.

What is claimed is:

1. A method comprising:
forming a first layer comprising a non-hexavalent chromium chemical conversion coating on a metal surface; and
forming a second layer on the first layer through a sol gel process.

2. The method of claim 1, wherein the second layer is formed on the first layer such that second layer is separated from the metal surface by the first layer.

3. The method of claim 1, wherein forming the second layer comprises immersing the metal surface in a solution comprising a sol gel composition.

4. The method of claim 1, wherein forming the second layer comprises introducing the second layer and then curing the second layer.

5. The method of claim 1, wherein the metal surface comprises aluminum and forming the first layer comprises reacting the aluminum with a trivalent chromium moiety.

6. An apparatus comprising:
a metal component having at least one surface;
a first layer comprising a non-hexavalent chromium chemical conversion coating on the at least one surface; and
a second layer derived from a sol gel composition on the first layer.

7. The apparatus of claim 6, wherein the second layer is formed on the first layer such that second layer is separated from the metal surface by the first layer.

8. The apparatus of claim 7, wherein the at least one surface of the metal component comprises aluminum.

9. The apparatus of claim 8, wherein the first layer comprises a reaction product of aluminum and a trivalent chromium moiety.

10. The apparatus of claim 6, wherein the sol gel composition comprises zirconium.

11. The apparatus of claim 6, wherein the metal component comprises a fastener.

12. The apparatus of claim 11, wherein the metal component comprises a rivet.
